(19) United States
(12) Patent Application Publication
(10) Pub. No.: US 2005/0288440 A1
(43) Pub. Date: Dec. 29, 2005

(54) Polyolefin foams for footwear foam applications

(76) Inventors: Richard T. Chou, Hockessin, DE (US); Kye Hyun Kim, Seoul (KR); Wayne Curtis Whelchel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/157,895

(22) Filed: Jun. 21, 2005

Related U.S. Application Data
(60) Provisional application No. 60/581,441, filed on Jun. 21, 2004.

(51) Int. Cl. C08L 1/00

(52) U.S. Cl. 525/191

(57) ABSTRACT

A composition that can be used as foam composition is disclosed, which comprises or is produced from about 40 to about 95 wt %, or about 50 to about 95 wt %, of an ethylene acrylate copolymer and about 5 to about 60 wt %, or about 5 to about 50 wt %, of a soft ethylene polymer wherein the ethylene acrylate copolymer comprises repeat units derived from ethylene and at least one alkyl acrylate and the soft ethylene polymer comprises copolymer of ethylene and an α-olefin, copolymer of ethylene and vinyl acetate, or combinations thereof.

This application claims the priority to U.S. provisional application Ser. No. 60/581,441, filed Jun. 21, 2004, the entire disclosure of which is incorporated herein by reference.

The invention relates to a polymer composition that can be used as a foam composition and to an article produced therefrom.

### BACKGROUND OF THE INVENTION

Polyolefinic materials encompass a variety of polymers ranging from semi-rigid polypropylene (PP) to soft ethylene polymers. They can be used to produce a variety of foam products. Most polyolefin foams are closed-cell foams, which are buoyant, resilient, tough, flexible, and resistant to chemicals and abrasion. Therefore, polyolefin foams are useful for packaging, construction, insulation, sports, leisure and footwear applications.

Copolymers of ethylene and vinyl acetate (EVA) have been widely used as base resin polymers in foam applications for many years. Crosslinked EVA foams, expanded with chemical blowing agents, provide an attractive balance of resilience, durability and other physical properties required for soling applications in footwear. These properties are provided at low density, which is desirable for lighter weight shoes, and at an attractive cost. EVA may presents limitations in attaining a balance of softness (e.g., surface softness), low compression set, and high resilience. Also, as foam processes move more toward one-step injection molding, achieving balanced properties using EVA foam may become difficult.

Foams made from ethylene acrylate copolymers (also referred to as ethylene-acrylic acid ester copolymers), such as ethylene-methyl acrylate copolymer (E/MA) with high MA content, are generally soft, have low density and are highly resilient.

E/MA foam may be weak in mechanical properties, such as tear strength and tensile strength, and may be difficult to crosslink.

There is a continued need to develop new products to expand the performance window of known polyolefin foams, such as the foam footwear market, to reduce costs, and to improve manufacturing process. It is also desirable to improve the crosslinking and mechanical properties while retaining the inherent merits of E/MA foams.

### SUMMARY OF THE INVENTION

The invention includes a composition that can be crosslinked to produce a foam composition comprising (a) an ethylene acrylate copolymer and (b) a soft ethylene polymer in which the ethylene acrylate copolymer comprises copolymer of ethylene and acrylate, ester of unsaturated carboxylic acid such as C₁-C₈ alkylacrylate, or combinations of two or more thereof and the soft ethylene polymer comprises copolymer of ethylene and an α-olefin, copolymer of ethylene and vinyl acetate, or combinations thereof.

The invention also includes a crosslinked foam composition comprising (a) about 40 to about 95 wt %, or about 50 to about 95 wt %, ethylene acrylate copolymer and (b) about 5 to about 60 wt %, or about 5 to about 50 wt %, of a soft ethylene polymer all based on the composition or combined weight of (a)+(b).

The invention further provides a foam article made from the foam compositions disclosed herein, as well as a midsole or insole for footwear.

### DETAILED DESCRIPTION OF THE INVENTION

“Copolymer” means a polymer comprising repeat units derived from two or more monomers or comonomers and thus including terpolymer or tetrapolymer.

Ethylene acrylate copolymer can comprise repeat units derived from ethylene and an ester of an unsaturated carboxylic acid such as a C₁ to C₈ alkyl acrylate, which refers to alkyl acrylate.

Examples of alkyl acrylates include methyl acrylate, ethyl acrylate and butyl acrylate. For example, “ethylene/methyl acrylate (E/MA)” means a copolymer of ethylene and methyl acrylate (MA); “ethylene/ethyl acrylate (E/EA)” means a copolymer of ethylene and ethyl acrylate (EA); “ethylene/butyl acrylate (E/BA)” means a copolymer of ethylene and butyl acrylate (BA); and includes both n-butyl acrylate and iso-butyl acrylate; and combinations of two or more thereof.

Alkyl acrylate comonomer incorporated into the ethylene acrylate copolymer can vary from 0.01 or 5 up to as high as 40 weight % of the total copolymer or even higher such as from 5 to 30, or 10 to 25, wt %.

Ethylene acrylate copolymer can also include another comonomer such as carbon monoxide, glycidyl acrylate, glycidyl methacrylate, and glycidyl vinyl ether, or combinations of two or more thereof.

Ethylene acrylate copolymers can be produced by processes well known in the polymer art using either autoclave or tubular reactors. The copolymerization can be run as a continuous process in an autoclave as disclosed in U.S. Pat. Nos. 3,264,272; 4,351,931; 4,248,990; and 5,028,674 and International Patent Application WO99/25742. Tubular reactor-produced ethylene acrylate copolymer can be distinguished from the more conventional autoclave produced ethylene acrylate copolymer as generally known in the art. Tubular reactor-produced ethylene acrylate copolymer are well known to one skilled in the art such as disclosed in U.S. Pat. Nos. 3,350,372; 3,756,996; and 5,532,066; the description of which is omitted herein for the interest of brevity. See also, “High flexibility E/MA made from high pressure tubular process.” Annual Technical Conference—Society of Plastics Engineers (2002), 60th (Vol. 2), 1832-1836.

Because these processes are well known to one skilled in the art, the description of which is omitted herein for the interest of brevity. Several ethylene acrylate copolymers such as Elvaloy® AC polymers are commercially available from E. I. du Pont de Nemours and Company (DuPont).

Soft ethylene polymer comprises copolymer of ethylene and an α-olefin copolymer, copolymer of ethylene and vinyl acetate (EVA), or combinations thereof. Soft ethylene polymer can be made by any processes well known in the art, including the use of Ziegler Natta catalysts, metallocene catalysts, and other catalysts useful in “low pressure” polymerization processes. EVA copolymers may be made in “high pressure” polymerization processes using, for example, free radical initiators. Because these processes are well known, the disclosure of which is omitted for the interest of brevity.

A soft ethylene polymer includes linear low-density polyethylene (LLDPE), metallocene-catalyzed polyethylene (MPE), EVA copolymer, or combinations of two or more thereof. MPE can have a density less than about 0.89 and a melt index (MI) of from about 0.1 to 100, or about 0.5 to 30, g/10 minutes, as measured using ASTM D-1238, condition E (190° C., 2160 gram weight). EVA preferably comprises at least about 15 wt % vinyl acetate. EVA copolymers suitable in the process of the present invention are available from several sources including the E. I. du Pont de Nemours anc Company, Wilmington, Del. (DuPont).

MPE is also referred to as metallocene polyethylene copolymer, copolymer of ethylene and an α-olefin monomer using a metallocene catalyst. MPE technology is capable of making lower density MPE with high flexibility and low crystallinity, which can be desirable as the second component of the invention. MPE technology is described in, for example, U.S. Pat. No. 5,272,236; U.S. Pat. No. 5,278,272, U.S. Pat. No. 5,507,475, U.S. Pat. No. 5,264,405, and U.S. Pat. No. 5,240,894. Without being held to theory, MPE may be preferred in the practice of the present invention because of its substantially linear structure and narrow molecular weight distribution. MPE copolymers include Dow Chemical Co under AFFINITY®, DuPont-Dow under the ENGAGE®, and Exxon Mobile under the EXACT® and PLASTOMER®.

The composition can also be a crosslinked foam composition including desired properties such as high resiliency, lower compression set, and most importantly foam softness. For example, foams derived from ethylene-methyl acrylate copolymer (E/MA) with high MA content may be soft, have low density, and are highly resilient. These properties are desirable in foam footwear applications, specifically for midsoles and insoles. The mechanical properties of E/MA foams, such as split tear resistance and tensile strength, may not be as desirable for maintaining long durability. Blending E/MA with a soft ethylene polymer may enhance E/MA mechanical properties and the degree of crosslinking. Crosslinking also may enhance melt strength for optimal foaming or improve the dimensional stability of the foam during shoe manufacturing. The degree of crosslinking is reflected in measurements of the maximum torque of foam. Higher values indicate an improved degree of curing leading to increased viscosity, thus improving foam stability and strength.

The foam composition can comprise about 95 to about 40 wt %, about 90 to about 50 wt %, or about 80 to about 60 wt % of an ethylene acrylate copolymer such as ethylene-methyl acrylate, ethylene-butyl acrylate, or ethylene-ethyl acrylate.

The ethylene acrylate copolymer may contain about 15 to about 40, or about 18 to about 35, wt % of acrylate comonomer based on the weight of the ethylene acrylate copolymer to maintain good elastomeric properties of the polymer.

The foam composition also comprises a soft ethylene polymer including LLDPE or MPE, each preferably has a density <about 0.89. The preferred MPE has a MI of from about 0.1 to 100, or about 0.5 to 30, g/10 minutes. The soft ethylene polymer can be present in the foam composition ranging from about 5 or about 10 to about 60%, or about 20 to about 40%, by weight.

The crosslinked composition may additionally comprise other polymers, different from the ethylene acrylate copolymer and soft ethylene polymer disclosed above to further enhance or balance desired foam properties. The optional polymer or polymers can be present in the composition ranging from about 0.5 to about 10 weight % based on the total weight of ethylene acrylate copolymer and soft ethylene polymer. The optional polymer can include low density polyethylene (LDPE) and LLDPE.

EVA may comprise at least about 15 wt %, or about 15 to about 35 wt %, or about 18 to about 30 wt %, vinyl acetate. The ethylene acrylate copolymer may have a melt index (MI) of from about 0.1 to 100, or about 0.5 to about 20 (for EVA, about 0.5 to 30), g/10 minutes, as measured using ASTM D-1238, condition E (190° C., 2160 gram weight).

The crosslinked composition may comprise one or more peroxide crosslinking agents, blowing agents, activators for the blowing agents, and other additives normally associated with such foam compositions.

Any free radical initiator crosslinking agent may be used including organic peroxides such as usually dialkyl organic peroxides. Examples of organic peroxides include 1,1-di-t-butyl peroxy-3,3,5-trimethylcyclohexane, t-butyl-cumyl peroxide, dicumyl-peroxide (DCP), 2,5-dimethyl-2,5-di(tertiary-butyl-peroxyl)hexane and 1,3-bis(tertiary-butyl-peroxy-isopropyl) benzene.

Wishing not to be bound by theory, crosslinking increases the viscosity and strength of the composition during foaming to settle the gas resulting from the decomposition in uniform and fine cells. The composition preferably comprises a crosslinking agent in concentrations that do not result in unstable cells, lack of uniformity in the foam, restriction of foam expansion (which may lead to higher density foams), and/or preventing decomposed gas from settling in uniform and fine cells (which may lead to abnormal foaming). The concentration can be in the range of about 0.01 to about 5, or about 0.2 to about 1.5, or about 0.2 to about 1.5 parts by weight of crosslinking agent for each 100 parts by weight of the composition.

The foam composition can also comprise, about 0.001 to about 5% by weight of the composition, a co-curing agent including trimethyl propane triacrylate (or similar compounds), N,N-m-phenylenedimaleimide, triallyl cyanuate, or combinations of two or more thereof.

The foam composition can also comprise, about 0.001 or about 0.2 to about 10% by weight of the composition, a blowing agent. A blowing agent can be a chemical blowing agent or a physical blowing agent. Physical blowing agents are halocarbons, volatile organic compounds, or non-flammable inert atmosphere gases. Chemical blowing agents include azodicarbonamide (ADCA), dinitroso-pentamethylene-tetramine (DPT), P-toluene sulfonyl hydrazide, and p.p′-oxybis(benzenesulfonyl hydrazide). To tailor expansion-decomposition temperature and foaming processes, a blowing agent may also be a mixture of blowing agents or of blowing agents with a blowing aid. For example, Vinyl for AK-2 (manufactured by Eiwa Kasei Chemical Co., Japan) is a mixture of ADCA and DPT. Uniroyal Chemical Celogen 765 is a modified ADCA.

The composition may also include about 1 to about 10% or about 2 to 6% by weight (of the composition) an activator (for the blowing agent) to lower the decomposition temperature/profile of blowing agents. A blowing agent activator can be one or more metal oxides, metal salts, or organometallic complexes. Examples include ZnO, Zn stearate, MgO, or combinations of two or more thereof.

Other additives may include any additives typically used in similar crosslinked polymer compositions and may include a pigment (TiO₂ and other compatible colored pigments), an adhesion promoter (to improve adhesion of the expanded foam to other materials), a filler (e.g., calcium carbonate, barium sulfate, and/or silicon oxide), a nucleating agent (pure form or concentrate form, e.g., CaCO₃ and/or SiO₂), rubber (to improve rubber-like elasticity, such as natural rubber, SBR, polybutadiene, and/or ethylene propylene terpolymer), a stabilizer (e.g., antioxidants, UV absorbers, and/or flame retardants), and a processing aids (e.g., Octene R-130 manufactured by Octene Co., Taiwan).

The foam composition may be produced by a number of methods, such as compression molding, injection molding and hybrids of extrusion and molding. The process can comprise mixing the polymers and crosslinking agents under heat to form a melt, along with blowing agents and other additives, to achieve a homogeneous compound. The ingredients may be mixed and blended by any means known in the art such as with a Banbury, intensive mixers, two-roll mill, and extruder. Time, temperature, shear rate may be regulated to ensure optimum dispersion without premature crosslinking or foaming. A high temperature of mixing may result in premature crosslinking and foaming by decomposition of peroxides and blowing agents. Yet, an adequate temperature is necessary to insure good mixing of the two main polymers, e.g., E/MA and MPE (and/or EVA), and the dispersion of other ingredients. E/MA and MPE can form a uniform blend when blended at temperatures of about 60 to about 150° C. or about 70° C. to about 120° C. The upper temperature limit for safe operation may depend on the onset decomposition temperatures of peroxides and blowing agents employed.

Optionally, polymers such as E/MA and MPE can be melt-blended in an extruder at a temperature up to about 250° C. to allow potentially good mixing. The resultant mixture can be then compounded with the ingredients disclosed above.

After mixing, shaping can be carried out. Sheeting rolls or calendar rolls are often used to make appropriately dimensioned sheets for foaming. An extruder may be used to shape the composition into pellets.

Foaming can be carried out in a compression mold at a temperature and time to complete the decomposition of peroxides and blowing agents. Pressures, molding temperature, and heating time may be controlled. Foaming can be carried out in an injection molding equipment by using foam composition in pellet form. The resulting foam can be further shaped to the dimension of finished products by any means known in the art such as by thermoforming and compression molding.

The resulting polymer foam composition can be substantially closed cell and useful for a variety of articles, e.g., footwear application including midsoles or insoles.

The invention is illustrated by the following examples, which are not meant to limit the scope of the invention.

### EXAMPLES

Test Methods:

The crosslinking properties were measured on a MDR-2000 Rheometer (A-Technology Co., Ohio) according to ASTM-2084 at condition similar to the foaming condition. The maximum torque was recorded in the following Table. Foam rebound resilience test was measured according to ASTM D 3574. The hardness of the foam was measured on a Type C (spring-type) hardness tester of ASKER, Japan according to ASTM D2240. Compression set was measured according to ASTM D3754 at the conditions of 50° C./6 hours. Split-tear was measured according to ASTM D3574. Compression strength testing was performed on an Instron Universal testing machine fitted with a compression cage deforming the foam samples at a uniform rate of 0.05 in./min. The stress required to produce compression strain up to 50% was determined. The compressive stress was determined as the force per unit area based on the original foam cross-section.

Sample Preparation:

Polymers and chemicals were weighed on a Mettler PC 2000 balance. This was followed by mixing. E/MA and MPE were charged into a Banbury (Bolling internal mixer). The mixer had a capacity of 1100 cc. The resins were fluxed at a temperature from 150° F.-200° F. After 1-2 minutes the remaining ingredients (except peroxide and blowing agent) were incorporated for 4-5 minutes. Then peroxide, blowing agents and other ingredients were added next. The mixing continued for 4-5 additional minutes, keeping the temperature under 200° F. The compound was discharged and transferred to a 6 inch×13 inch Boiling OX two-roll mill. The mill was oil heated and set for a temperature of 150° F. Batch size for the mill was about 500 to 1200 grams. Maximum speed was 35 feet per minute. Roll gap was adjusted to produce sheets for sample cutting (150 to 300 mils).

Samples were cut on a Hudson Hydraulic Clicker, using a 3 inch×3 inch die, and weighed to 90 g. The foaming process consisted of putting the 90 g sample into a 3 inch×3 inch beveled mold with an overall measurement of 6×6×½ inches. This was put between two 9 inch by 10 inch by ¼ inch aluminum plates. The plates and sample were placed into an automatic PHI press. Samples were typically in the press for 10-30 minutes at a temperature of about 155° C.-185° C. under pressure of about 3300 lbs. The foam was formed instantaneously when the mold was opened at the end of the molding cycle.

Results in the following table show that foams of ethylene acrylate copolymers exhibited softness (Comparative Examples A, B and C; foam hardness) that provided comfort in wearing and excellent resilience, which was desirable for performance, but exhibited low mechanical properties (split-tear strength and compression strength, e.g., Comp. Ex. B and C) and poor curing behavior (as reflected in the max. torque values, e.g., Comp. Ex. A).

Comparative Example A with 0.8 pph of peroxide had a low degree of curing as reflected from the low values of torque. Comparative Example B with 1.2 pph of peroxide exhibited a much higher torque, and the compression set was improved. However, the split-tear property deteriorates. Comparative Example C with 1 pph of peroxide and the addition of co-curing agent, triallyl Cyanuate, also improved the degree of curing and the compression set properties. Again the split-tear further deteriorated. It appeared from these results that balanced mechanical properties could not be achieved for E/MA foams.

The following table also shows that the foams made from a blend of E/MA and MPE (Examples 1, 2, 3 and 4) exhibited improved degree of curing (reflecting the degree of crosslinking, see maximum torque values) and mechanical properties as compared with the Comparative Examples. Also, the blend foams retained high resilience and high softness that were inherently attributes of E/MA foams. For example, Example 3 and Example 4 foams retained high resilience and desirable softness (see foam hardness values), low compression set, and good split-tear strength. The result show that at lower foam densities the split-tear strength, a measure of durability, achieved consistently higher values and achieved a desired balance of properties for footwear applications.

| | Max | Foaming | Foam | Foam | Compression | Split Tear | Compression | Rebound |
|---|---|---|---|---|---|---|---|---|
| | Torque | Condition | Density | Hardness | Set | Strength | Strength | Resilience |
| Example¹ | (kg-cm) | C/minutes | (g/cc) | (Asker C) | (%) | (N/M) | (PSI) | (%) |
| Comp Ex A | 0.74 | 165/20 | (g/cc) | 30 | 22 | 2.4 | 22 | |
| | 0.58 | 175/10 | 0.122 | 29 | | 2.6 | | 54 |
| Comp Ex B | 1.32 | 165/20 | 0.118 | 46 | | 1.9 | 34.5 | 51 |
| | | 175/10 | 0.162 | 42 | 36 | N/A | | 51 |
| Comp Ex C | 1.4 | 165/20 | 0.149 | 47 | | 1.6 | | |
| | | 175/10 | 0.28 | 42 | | 1.4 | | |
| Ex 1 | 1.23 | 165/20 | 0.166 | 32 | 23 | 2.3 | 35 | |
| | 1.08 | 175/10 | 0.125 | 28 | | 2.8 | | 55 |
| Ex 2 | 1.46 | 165/20 | 0.117 | 32 | 22.6 | 2.5 | 39.4 | |
| | 1.28 | 175/10 | 0.122 | 32 | | 2.7 | | 56 |
| Ex 3 | 1.93 | 165/20 | 0.117 | 43 | 36 | 2.1 | 28.3 | 54 |
| | | 175/10 | 0.16 | 40 | 34 | N/A | | 55 |
| Ex 4 | 2.27 | 165/20 | 0.144 | 51 | 58 | 2.4 | 43.7 | 53 |
| | | 175/10 | 0.215 | 47 | 42 | N/A | | 55 |

¹Peroxide present was Comparative Example A (0.8 pph, parts per 100 parts of the composition);
Comparative Example B (1.2 pph);
Comparative Example C (1 pph);
Example 1 (0.8 pph);
Example 2 (0.8 pph);
Example 1 (1 pph);
Example 1 (1.2 pph).

### COMPOSITION OF THE EXAMPLES

Examples and comparative examples used E/MA (ethylene/methyl acrylate copolymer containing 24 wt % MA with a MI of 2.0, DuPont) and Celogen 765 (from Uniroyal Co.) as blowing agent. MPE was a metallocene catalyst produced ethylene α-olefin copolymer with a density of 0.87 g/cc and a MI of 1 from DuPont Dow Elastomers LLC.
Comparative Example A: E/MA, 832 g; DCP, 6.7 g; blowing agent, 30 g; Zn stearate, 8.0 g; ZnO, 8.0 g; Stearic acid, 4.0 g; CaCO₃, 25 g.
Comparative Example B: E/MA, 832 g; DCP, 10.0 g; blowing agent, 30 g; Zn stearate, 4.0 g; Stearic acid, 4.0 g; CaCO₃, 25 g.
Comparative Example C: E/MA, 832 g; DCP, 8.5 g; Triallyl Cyanuate, 4.5 g; blowing agent, 25 g; Zn stearate, 4.0 g; Stearic acid, 4.0 g; CaCO₃, 25 g
Example 1: E/MA, 550 g; MPE, 276 g; DCP, 6.7 g; blowing agent, 30 g; Zn stearate, 8.0 g; ZnO, 8.0 g; Stearic acid, 4.0 g; CaCO₃, 25 g.
Example 2: E/MA, 450 g; MPE, 382 g; DCP, 6.7 g; blowing agent, 30 g; Zn stearate, 8.0 g; ZnO, 8.0 g; Stearic acid, 4.0 g; CaCO₃, 25 g.
Example 3: E/MA, 500 g; MPE, 333 g; DCP, 8.3 g; blowing agent, 30 g; Zn stearate, 8.0 g; ZnO, 8.0 g; Stearic acid, 4.0 g; CaCO₃, 25 g.
Example 4 has the same formulation of Example 3 except containing 10 g DCP.

1. A composition comprising or produced from about 40 to about 95 wt %, or about 50 to about 95 wt %, of an ethylene acrylate copolymer and about 5 to about 60 wt %, or about 5 to about 50 wt %, of a soft ethylene polymer wherein the ethylene acrylate copolymer comprises repeat units derived from ethylene and at least one alkyl acrylate and the soft ethylene polymer comprises copolymer of ethylene and an α-olefin, copolymer of ethylene and vinyl acetate, or combinations thereof.

2. The composition of claim 1 wherein the soft ethylene polymer is a very low-density polyethylene, a metallocene catalyst-produced ethylene copolymer having a density less than about 0.89 g/cc, a polyethylene vinyl acetate comprising at least about 15 weight % repeat units derived from vinyl acetate, or combinations thereof.

3. The composition of claim 1 further comprising about 0.2 to about 1.5 wt % crosslinking agent(s), about 0.5 to about 10 wt % blowing agent(s), about 0.1 to about 10 wt % activator(s), and optionally, about 0.1 to about 1 wt % co-curing agent(s).

4. The composition of claim 2 further comprising about 0.2 to about 1.5 wt % crosslinking agent(s), about 0.5 to about 10 wt % blowing agent(s), about 0.1 to about 10 wt % activator(s), and optionally, about 0.1 to about 1 wt % co-curing agent(s).

5. The composition of claim 3 wherein the ethylene acrylate copolymer comprises repeat units derived from methyl acrylate.

6. The composition of claim 4 wherein the ethylene acrylate copolymer comprises repeat units derived from methyl acrylate.

7. The composition of claim 6 wherein the soft ethylene polymer is the metallocene catalyst-produced ethylene copolymer.

8. The composition of claim 4 wherein the ethylene acrylate copolymer comprises repeat units derived from methyl acrylate.

9. The composition of claim 1 wherein the ethylene acrylate copolymer is present in about 50 to about 90 wt % and the soft ethylene polymer is present in about 10 to about 50 wt %.

10. The composition of claim 9 wherein the soft ethylene polymer is a very low-density polyethylene, a metallocene catalyst-produced ethylene copolymer having a density less than about 0.89 g/cc, a polyethylene vinyl acetate comprising at least about 15 weight % vinyl acetate repeat units, or combinations thereof.

11. The composition of claim 10 further comprising about 0.2 to about 1.5 wt % crosslinking agent(s), about 0.5 to about 10 wt % blowing agent(s), about 0.1 to about 10 wt % activator(s), and optionally, about 0.1 to about 1 wt % co-curing agent(s).

12. The composition of claim 11 wherein the soft ethylene polymer is the metallocene catalyst-produced ethylene acrylate copolymer.

13. The composition of claim 12 wherein the ethylene acrylate copolymer comprises about 10 to about 40 wt % of methyl acrylate comonomer.

14. The composition of claim 13 additionally comprising a polymer selected from the group consisting of low density polyethylene and linear low density polyethylene.

15. An article comprises or produced from a composition wherein the article includes midsole for footwear, insole for footwear, or both and the composition is as recited in claim 1.

16. The article according to claim 15 wherein the composition is as recited in claim 4.

17. The article according to claim 15 wherein the composition is as recited in claim 6.

18. The article according to claim 15 wherein the composition is as recited in claim 7

19. The article according to claim 15 wherein the composition is as recited in claim 8.

20. The article according to claim 15 wherein the composition is as recited in claim 12.
